(19) United States
(12) Patent Application Publication
(10) Pub. No.: US 2008/0117186 A1
(43) Pub. Date: May 22, 2008

(54) TOUCH PANEL MODULE AND METHOD OF FABRICATING THE SAME

(75) Inventors: Chun-Hao Wang, Changhua County (TW); Ping-Wen Huang, Taichung City (TW); Chiu-Mei Liu, Taichung City (TW); Pheng-Chih Yu, Penghu County (TW); Chin-Pei Hwang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: WINTEK CORPORATION, Taichung (TW)

(21) Appl. No.: 11/937,511

(22) Filed: Nov. 9, 2007

Related U.S. Application Data
(60) Provisional application No. 60/864,975, filed on Nov. 9, 2006.

(51) Int. Cl. G06F 3/045; G06F 3/041

(52) U.S. Cl. 345/174; 345/173

(57) ABSTRACT

A touch panel module including a cover and a transparent touch panel is provided. At least a portion of the transparent touch panel is directly connected to the cover. A method of fabricating the touch panel module including the following steps is also provided. First, a transparent touch panel is provided. Next, the cover is formed using injection molding technology such that at least a portion of the transparent touch panel is directly connected to the cover.

### CROSS-REFERENCE TO RELATED APPLICATION

This application claims the priority benefit of U.S. provisional application Ser. No. 60/864,975, filed on Nov. 9, 2006. The entirety of the above-mentioned patent application is hereby incorporated by reference herein and made a part of this specification.

### BACKGROUND OF THE INVENTION

1. Field of the Invention

The present invention relates to a panel module and a method of fabricating the same. More particularly, the present invention relates to a touch panel module and a method of fabricating the same.

2. Description of Related Art

In today's world, people are becoming more and more dependent on electronic devices. Electronic products such as notebook computers, mobile phones, personal digital assistants (PDAs), and digital walkmans are becoming indispensable in people's day-to-day life and work. The above-mentioned electronic products are all installed with a human-machine interface, and each is equipped with an internal system that automatically executes the command inputted by a user. Currently, some of the most widely used human-machine interfaces include keyboards, mice, and touch panels.

Please refer to FIG. 1, which is a schematic cross-sectional view illustrating a conventional touch panel module. A conventional touch panel module 100 includes a cover 110, a transparent capacitive touch panel 120, and an optically clear adhesive (OCA) 130. A transparent part 112 of the cover 110 is enclosed by the optically clear adhesive 130. Further, the optically clear adhesive 130 is disposed on a housing 114 of the cover 110. In addition, the transparent capacitive touch panel 120 is bonded to the cover 110 by the optically clear adhesive 130. However, due to the presence of an air gap G present between the transparent part 112 and the transparent capacitive touch panel 120, the overall transmittance of the conventional touch panel module 100 is adversely affected.

To overcome the above-mentioned shortcomings, another conventional touch panel module 200 has been proposed. Please refer to FIG. 2, which is a schematic cross-sectional view illustrating another conventional touch panel module. The difference between the touch panel module 200 and the touch panel module 100 is that a transparent capacitive touch panel 220 is bonded to a cover 210 by a complete sheet of optically clear adhesive 230. Nevertheless, after the optically clear adhesive 230 and the cover 210 are bonded, the optically clear adhesive 230 cannot be smoothly bonded to the transparent capacitive touch panel 220 to cause the presence of bubbles between the optically clear adhesive 230 and the transparent capacitive touch panel 220. On the other hand, after the optically clear adhesive 230 and the transparent capacitive touch panel 220 are bonded, the optically clear adhesive 230 cannot be smoothly bonded to the cover 210, resulting in the presence of bubbles between the optically clear adhesive 230 and the cover 210. As a result, the optical properties and the product appearance of the touch panel module 200 are affected.

### SUMMARY OF THE INVENTION

The present invention is directed to a touch panel module with an improved overall transmittance.

The present invention is directed to a method of fabricating a touch panel module with an improved overall transmittance.

The present invention is directed to a touch panel module including a cover and a transparent touch panel. At least a portion of the transparent touch panel is directly connected to the cover.

In one embodiment of the present invention, the transparent touch panel may be disposed on a surface of the cover.

In one embodiment of the present invention, at least a portion of the transparent touch panel may be directly inserted into the cover. The cover includes a transparent part and a housing. The transparent part is disposed on the transparent touch panel. The housing has a hole. Further, the transparent part and at least a portion of the transparent touch panel are directly inserted into the hole. In addition, the material used for fabricating the transparent part includes polycarbonate (PC), acrylic resin or other transparent plastic material.

In another embodiment of the present invention, the cover includes a transparent part and a housing. The transparent part has a trough. Further, at least a portion of the transparent touch panel is directly inserted into the trough. The housing has a hole. Further, at least a portion of the transparent part and at least a portion of the transparent touch panel are directly inserted into the hole. In addition, the material used for fabricating the transparent part includes polycarbonate, acrylic resin or other transparent plastic material.

In one embodiment of the present invention, the transparent touch panel may be a transparent capacitive touch panel.

The present invention is directed to a method of fabricating a touch panel module, which includes the following steps. First, a transparent touch panel is provided. Next, a cover is formed using injection molding technology to directly connect at least a portion of the transparent touch panel to the cover.

In one embodiment of the present invention, the transparent touch panel may be disposed on a surface of the cover.

In one embodiment of the present invention, at least a portion of the transparent touch panel may be directly inserted into the cover. The step of forming the cover using injection molding technology includes the following processes. First, a housing is formed using injection molding technology. Herein, the housing includes a hole and at least a portion of the transparent touch panel is directly inserted into a portion of the hole. Next, a transparent part is formed on the transparent touch panel using injection molding technology to directly insert the transparent part into another portion of the hole.

In another embodiment of the present invention, the step of forming the cover using injection molding technology includes the following processes. First, a transparent part is formed on the transparent touch panel using injection molding technology. Next, a housing is formed using injection molding technology. Herein, the housing includes a hole, and a portion of the transparent part and at least a portion of the transparent touch panel are directly inserted into the hole.

In yet another embodiment of the present invention, the step of forming the cover using injection molding technology includes the following processes. First, a transparent part is formed using injection molding technology. Herein, the transparent part includes a trough, and at least a portion of the transparent touch panel is directly inserted into the trough. Next, a housing is formed using injection molding technology. Herein, the housing includes a hole, and at least a portion of the transparent part and at least a portion of the transparent touch panel are directly inserted into the hole.

In one embodiment of the present invention, a cover is formed using in-mold decoration (IMD) injection molding technology.

Since the transparent touch panel of the touch panel module according to the present invention, unlike the conventional art, is not bonded to the cover using an optically clear adhesive. As a result, when a user is using an electronic device installed with the touch panel module of the present invention, the user is able to clearly read the information displayed on the transparent touch panel of the electronic device. In other words, the touch panel module of the present invention has a better overall transmittance. Further, the thickness of the touch panel module of the present invention is comparatively thinner. In addition, the method of fabricating a touch panel module according to the present invention has a higher process yield and a higher production capacity.

In order to make the aforementioned and other objects, features and advantages of the present invention more comprehensible, preferred embodiments accompanied with figures are described in detail below.

### BRIEF DESCRIPTION OF THE DRAWINGS

FIG. 1 is a schematic cross-sectional view illustrating a conventional touch panel module.

FIG. 2 is a schematic cross-sectional view illustrating another conventional touch panel module.

FIG. 3A is a schematic three-dimensional view illustrating an electronic device according to the first embodiment of the present invention.

FIG. 3B is a schematic cross-sectional view illustrating the electronic device shown in FIG. 3A along the line I-I′.

FIG. 3C is a partially enlarged schematic view illustrating the transparent touch panel shown in FIG. 3B.

FIG. 4A through FIG. 4C are schematic views illustrating a method of fabricating the touch panel module according to the first embodiment of the present invention.

FIG. 5A through FIG. 5C are schematic views illustrating another method of fabricating the touch panel module according to the first embodiment of the present invention.

FIG. 6 is a schematic cross-sectional view illustrating a touch panel module according to the second embodiment of the present invention.

FIG. 7A through FIG. 7C are schematic views illustrating a method of fabricating the touch panel module according to the second embodiment of the present invention.

FIG. 8 is a schematic cross-sectional view illustrating a touch panel module according to the third embodiment of the present invention.

### DESCRIPTION OF EMBODIMENTS

### First Embodiment

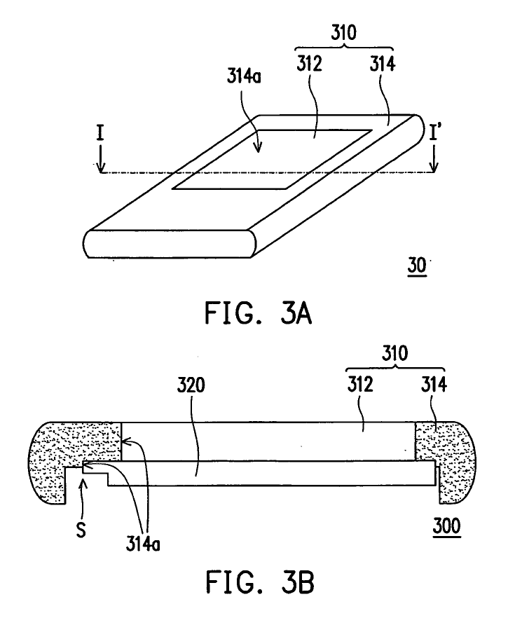

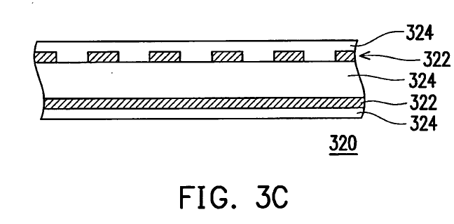

FIG. 3A is a schematic three-dimensional view illustrating an electronic device according to the first embodiment of the present invention, and FIG. 3B is a schematic cross-sectional view illustrating the electronic device shown in FIG. 3A along the line I-I′. Please refer to FIG. 3A and FIG. 3B. In the first embodiment, a touch panel module 300 that is suitable for use in an electronic device 30 is provided. Examples of the electronic device 30 include personal digital assistants, mobile phones, notebook computers or industrial control panels. The touch panel module 300 of the first embodiment includes a cover 310 and a transparent touch panel 320. At least a portion of the transparent touch panel 320 is directly connected to the cover 310. In the first embodiment, the transparent touch panel 320 may be directly inserted into the cover 310.

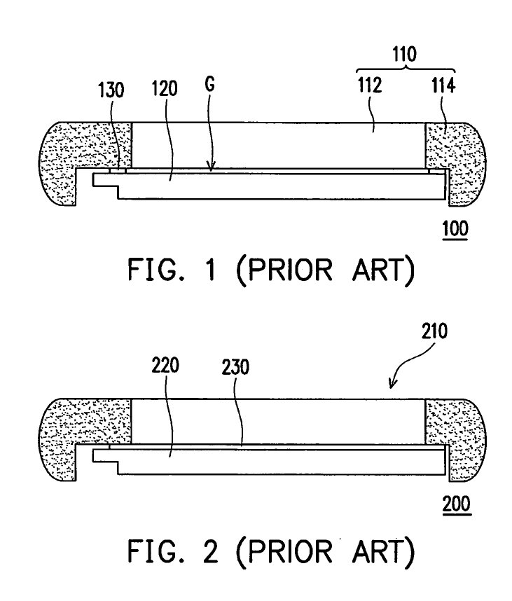

Unlike the conventional art, the transparent touch panel 320 is not bonded to the cover 310 using the optically clear adhesives 130 and 230 (See FIG. 1 and FIG. 2). As a result, when a user is using the electronic device 30, the user is able to clearly read the information displayed on the transparent touch panel 320 of the electronic device 30. In other words, the touch panel module 300 has a better overall transmittance.

In the first embodiment, the cover 310 includes a transparent part 312 and a housing 314. The transparent part 312 is disposed on the transparent touch panel 320. The housing 314 has a hole 314a. Further, the transparent part 312 and at least a portion of the transparent touch panel 320 are directly inserted into the hole 314a. To be specific, the shape of the hole 314a is like a two level ladder and the transparent part 312 as well as the transparent touch panel 320 are inserted into the hole 314a. Further, the transparent part 312 and the transparent touch panel 320 may stuff the hole 314a up. The transparent touch panel 320 may be partially inserted or completely embedded into the cover 310 according to the design requirement. Further, the material used for fabricating the transparent part 312 includes polycarbonate, acrylic resin or other transparent plastic material. It should be noted that a reserved space S between the transparent touch panel 320 and the housing 314 can be set aside to allow a flexible circuit board (not shown) that is electrically connected to the transparent touch panel 320 and the other internal circuit device (not shown) in the electronic device 30 to bend in the reserved space S.

FIG. 3C is a partially enlarged schematic view illustrating the transparent touch panel shown in FIG. 3B. Please refer to FIG. 3B and FIG. 3C. The transparent touch panel 320 of the first embodiment may be a transparent capacitive touch panel. For example, the transparent capacitive touch panel includes two transparent electrode circuit layers 322 and three transparent dielectric layers 324. The topmost transparent dielectric layer 324 and the bottommost transparent dielectric layer 324 may be thinner carbon dioxide layers, and the middle transparent dielectric layer 324 may be a thicker transparent substrate. Certainly, according to a different design requirement, the topmost and the bottommost transparent dielectric layers 324 may be thicker transparent substrates, and the middle transparent dielectric layer 324 may be a thinner layer of dielectric material or optical adhesive, which are not illustrated in the figures. The transparent electrode circuit layers 322 and the transparent dielectric layers 324 are alternately disposed. Further, the arrangement direction of the circuits of the transparent electrode circuit layer 322 is perpendicular to that of the circuits of the other transparent electrode circuit layer 322. When a user touches the transparent part 312 of the cover 310, the capacitance of the point where the transparent touch panel 320 is pressed is changed and an electrical signal is thus outputted.

It should be noted that the components and the appearance of the transparent capacitive touch panel can be modified and varied according to the design requirement. The transparent capacitive touch panel described above is merely an example to illustrate the present invention. Hence, the present invention is not limited thereto. Further, the transparent touch panel 320 of the first embodiment is also not limited to transparent capacitive touch panel. Specifically, the transparent touch panel 320 of the first embodiment can be any other type of transparent touch panel according to the design requirement.

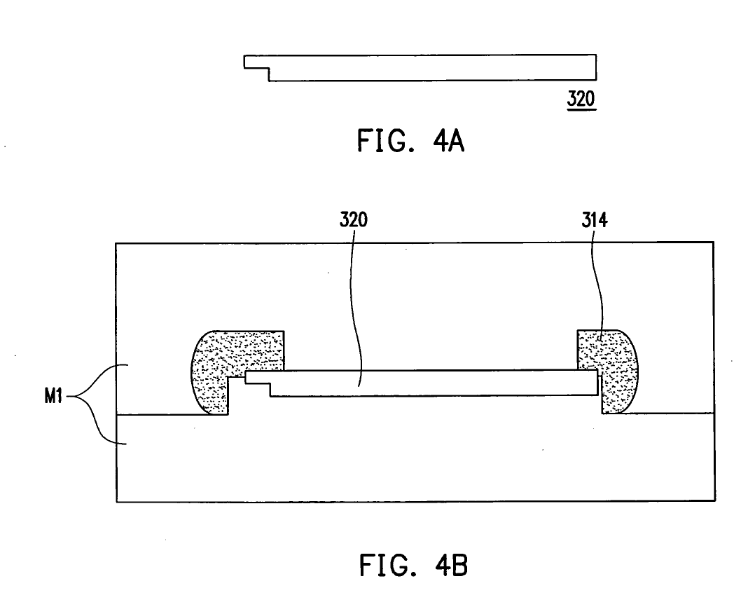

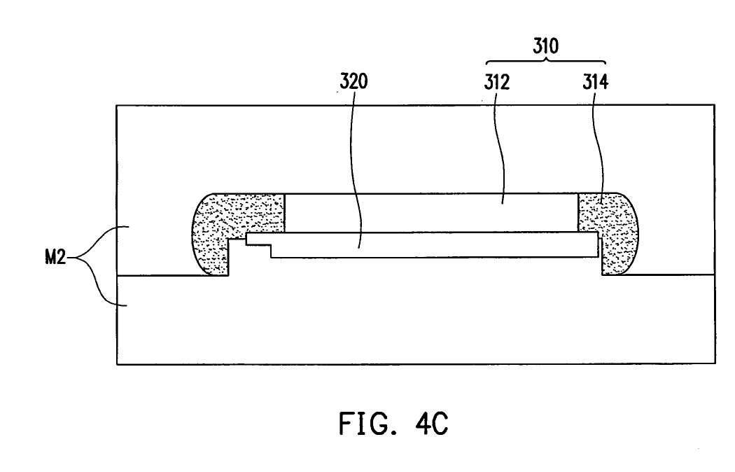

The following is a description of the process for fabricating the touch panel module 300 of the first embodiment. FIG. 4A through FIG. 4C are schematic views illustrating a method of fabricating the touch panel module according to the first embodiment of the present invention. First, please refer to FIG. 4A. A transparent touch panel 320 is provided. Next, please refer to FIG. 4B and FIG. 4C. A cover 310 is formed using injection molding technology to directly connect at least a portion of the transparent touch panel 320 to the cover 310. In the first embodiment, at least a portion of the transparent touch panel 320 may be directly inserted into the cover 310.

More specifically, in the first embodiment, the step of forming the cover 310 using injection molding technology includes the following processes. First, please refer to FIG. 4B. The transparent touch panel 320 may be placed in a mold M1. A housing 314 is formed by injecting plastic into the mold M1 using in-mold decoration (IMD) injection molding technology. The housing 314 has an hole 314a (See FIG. 3B). Further, at least a portion of the transparent touch panel 320 is directly inserted into a portion of the hole 314a (See FIG. 3B). Next, please refer to FIG. 4C. The semi-product composed of the transparent touch panel 320 and the housing 314 may be place in another mold M2. A transparent part 312 is formed on the transparent touch panel 320 using IMD injection molding technology to directly insert the transparent part 312 into another portion of the hole 314a (See FIG. 3B).

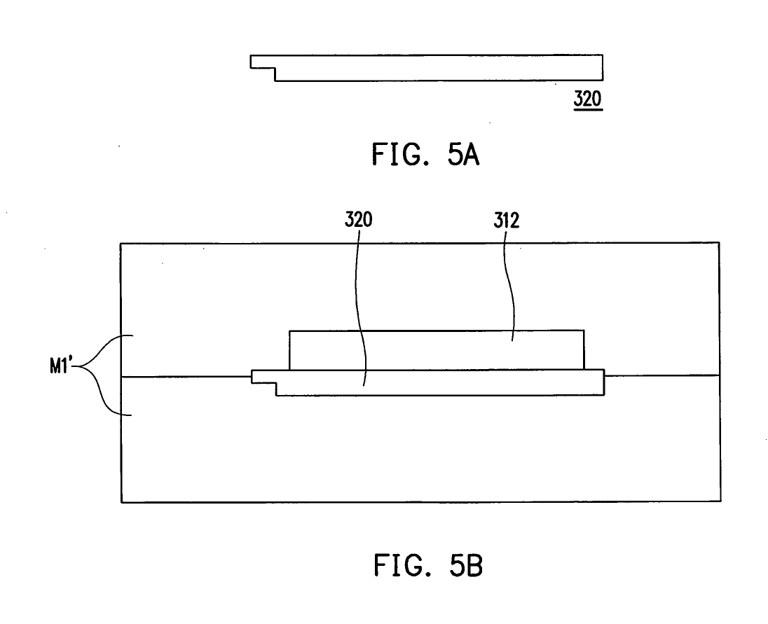

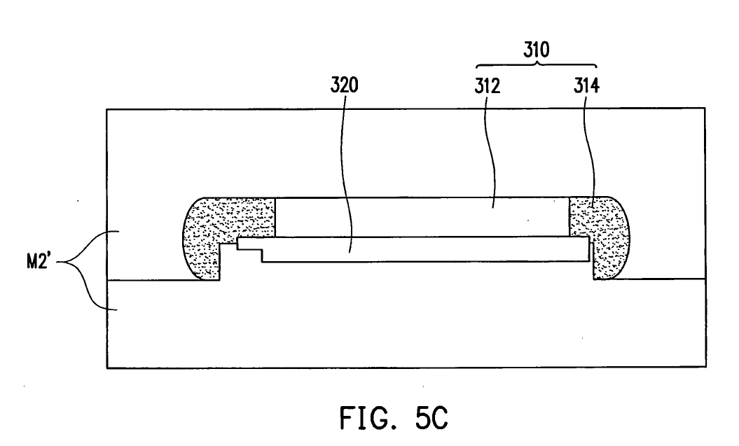

Besides, there is another process for fabricating the touch panel module 300 of the first embodiment. FIG. 5A through FIG. 5C are schematic views illustrating another method of fabricating the touch panel module according to the first embodiment of the present invention. First, please refer to FIG. 5A. A transparent touch panel 320 is provided. Next, please refer to FIG. 5B and FIG. 5C. A cover 310 is formed using injection molding technology to directly insert at least a portion of the transparent touch panel 320 into the cover 310.

More specifically, in the first embodiment, the step of forming the cover 310 using injection molding technology includes the following processes. First, please refer to FIG. 5B. The transparent touch panel 320 may be placed in a mold M1′, and a transparent part 312 may be formed on the transparent touch panel 320 using IMD injection molding technology. Next, please refer to FIG. 5C. The semi-product composed of the transparent touch panel 320 and the transparent part 312 may be placed in another mold M2′. A housing 314 is formed by injecting plastic into the mold M2′ using IMD injection molding technology. The housing 314 has an hole 314a (See FIG. 3B). Further, the transparent part 312 and at least a portion of the transparent touch panel 320 are directly inserted into the hole 314a (See FIG. 3B).

### Second Embodiment

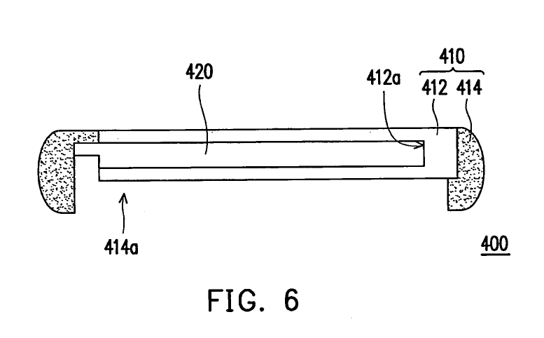

Please refer to FIG. 6, which is a schematic cross-sectional view illustrating a touch panel module according to the second embodiment of the present invention. The appearance of a touch panel module 400 of the second embodiment is different from that of the touch panel module 300 of the first embodiment. In the second embodiment, a transparent part 412 of a cover 410 has a trough 412a. Further, at least a portion of a transparent touch panel 420 is directly inserted into the trough 412a. In addition, a housing 414 of the cover 410 has a hole 414a. Further, at least a portion of the transparent part 412 and at least a portion of the transparent touch panel 420 are directly inserted into the hole 414a.

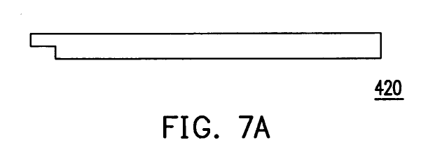

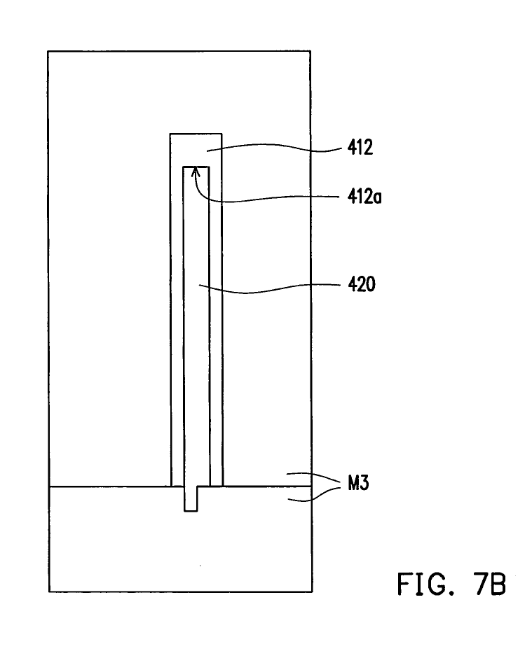

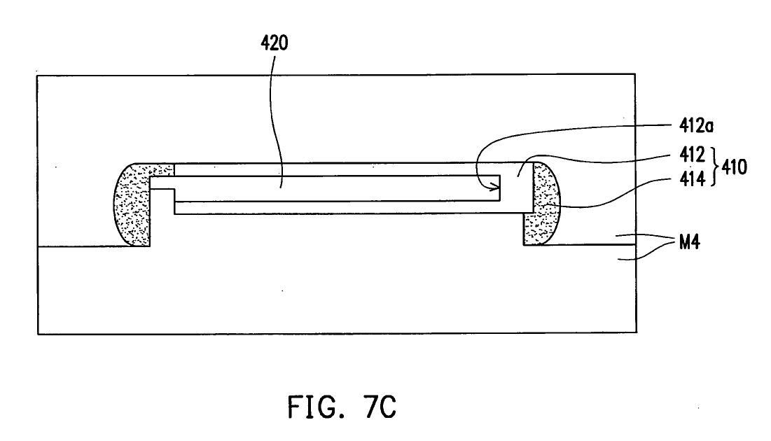

The following is a description of the process for fabricating the touch panel module 400 of the second embodiment. FIG. 7A through FIG. 7C are schematic views illustrating a method of fabricating the touch panel module according to the second embodiment of the present invention. First, please refer to FIG. 7A. A transparent touch panel 420 is provided. Next, please refer to FIG. 7B and FIG. 7C. A cover 410 is formed using injection molding technology to directly insert at least a portion of the transparent touch panel 420 into the cover 410.

More specifically, in the second embodiment, the step of forming the cover 410 using injection molding technology includes the following processes. First, please refer to FIG. 7B. The transparent touch panel 420 may be placed in a mold M3. A transparent part 412 may be formed using IMD injection molding technology to directly insert at least a portion of the transparent touch panel 420 into the trough 412a of the transparent part 412. Thereafter, please refer to FIG. 7C. The semi-product composed of the transparent touch panel 420 and the transparent part 412 may be placed in another mold M4. A housing 414 may be formed using IMD injection molding technology to directly insert at least a portion of the transparent part 412 and at least a portion of the transparent touch panel 420 into the hole 414a of the housing 414.

### Third Embodiment

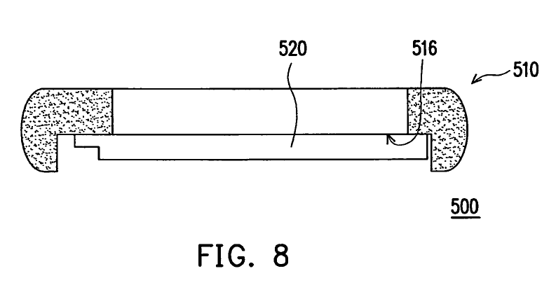

Please refer to FIG. 8, which is a schematic cross-sectional view illustrating a touch panel module according to the third embodiment of the present invention. The major difference between the third embodiment and the above-mentioned embodiments is that a transparent touch panel 520 of a touch panel module 500 may be disposed on a surface 516 of a cover 510.

It should be noted that the appearance of the covers 310, 410 and 510 may be modified such as a flat plate according to the design requirement. However, the above-mentioned embodiments are merely examples used to illustrate the present invention. Hence, the present invention is not limited thereto.

In view of the above, the touch panel module and the method of fabricating the same according to the present invention have at least the following advantages:

Since the transparent touch panel of the touch panel module according to the present invention, unlike the conventional art, does not utilize an optically clear adhesive to bond to the cover, when a user is using an electronic device installed with the touch panel module of the present invention, the user is able to clearly read the information displayed on the transparent touch panel of the electronic device. In other words, the touch panel module of the present invention has a better overall transmittance.

Since the transparent touch panel of the touch panel module according to the present invention, unlike the conventional art, does not utilize an optically clear adhesive to bond to the cover, the thickness of the touch panel module according to the present invention is comparatively thinner.

Since the transparent touch panel of the touch panel module according to the present invention, unlike the conventional art, does not utilize an optically clear adhesive to bond to the cover, the transparent touch panel according to the present invention can be directly inserted into the cover using IMD injection molding technology. Hence, the method of fabricating the touch panel module according to the present invention has a higher process yield and a higher production capacity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel module, comprising:
a cover; and
a transparent touch panel, wherein at least a portion of the transparent touch panel is directly connected to the cover.

2. The touch panel module of claim 1, wherein the transparent touch panel is disposed on a surface of the cover.

3. The touch panel module of claim 1, wherein at least a portion of the transparent touch panel is directly inserted into the cover.

4. The touch panel module of claim 3, wherein the cover comprises:
a transparent part disposed on the transparent touch panel; and
a housing having a hole, wherein the transparent part and at least a portion of the transparent touch panel are directly inserted into the hole.

5. The touch panel module of claim 4, wherein the material used for fabricating the transparent part is polycarbonate, acrylic resin or other transparent plastic material.

6. The touch panel module of claim 3, wherein the cover comprises:
a transparent part having a trough, wherein at least a portion of the transparent touch panel is directly inserted into the trough; and
a housing having a hole, wherein at least a portion of the transparent part and at least a portion of the transparent touch panel are directly inserted into the hole.

7. The touch panel module of claim 6, wherein the material used for fabricating the transparent part is polycarbonate, acrylic resin or other transparent plastic material.

8. The touch panel module of claim 1, wherein the transparent touch panel is a transparent capacitive touch panel.

9. A method of fabricating a touch panel module, comprising:
providing a transparent touch panel; and
forming a cover using injection molding technology to directly connect at least a portion of the transparent touch panel to the cover.

10. The method of claim 9, wherein the transparent touch panel is disposed on a surface of the cover.

11. The method of claim 9, wherein at least a portion of the transparent touch panel is directly inserted into the cover.

12. The method of claim 11, wherein the method of forming the cover using injection molding technology comprises:
forming a housing injection molding technology, wherein the housing has a hole and at least a portion of the transparent touch panel is directly inserted into a portion of the hole; and
forming a transparent part on the transparent touch panel using injection molding technology to directly insert the transparent part into another portion of the hole.

13. The method of claim 11, wherein the method of forming the cover using injection molding technology comprises:
forming a transparent part on the transparent touch panel using injection molding technology; and
forming a housing injection molding technology, wherein the housing has a hole, and the transparent part and at least a portion of the transparent touch panel are directly inserted into the hole.

14. The method of claim 11, wherein the method of forming the cover using injection molding technology comprises:
forming a transparent part using injection molding technology, wherein the transparent part has a trough, and at least a portion of the transparent touch panel is directly inserted into the trough; and
forming a housing injection molding technology, wherein the housing has a hole, and at least a portion of the transparent part and at least a portion of the transparent touch panel are directly inserted into the hole.

15. The method of claim 9, wherein the cover is formed using in-mold decoration injection molding technology.

16. A touch panel module, comprising:
a housing having a hole with the hole's shape like a two level ladder;
a transparent part inserted into the hole; and
a transparent touch panel disposed on the transparent part and at least a portion of the transparent touch panel inserted into the hole and directly contact the surface of the housing.

17. The touch panel module of claim 16, wherein the transparent part and the transparent touch panel both stuff the hole up.

18. The touch panel module of claim 16, wherein the transparent touch panel is a transparent capacitive touch panel.
